(19) United States
(12) Patent Application Publication
(10) Pub. No.: US 2007/0057917 A1
(43) Pub. Date: Mar. 15, 2007

(54) Portable digital apparatus for conveniently inputting various characters and method of controlling the apparatus

(75) Inventor: Sung-cheol Bae, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/353,373

(22) Filed: Feb. 13, 2006

(30) Foreign Application Priority Data
Sep. 10, 2005 (KR) 10-2005-0084423

(51) Int. Cl. G09G 5/08

(52) U.S. Cl. 345/158

(57) ABSTRACT

Provided is a method and apparatus for inputting text into a portable digital apparatus. The method includes: allocating at least two characters of different language character sets to at least one input button; and selecting any one of the language character sets according to an inclination of the apparatus.

### CROSS-REFERENCE TO RELATED PATENT APPLICATIONS

This application claims the priority of Korean Patent Application No. 10-2005-0084423, filed on Sep. 10, 2005, in the Korean Intellectual Property Office, the disclosure of which is incorporated herein in its entirety by reference.

### BACKGROUND OF THE INVENTION

1. Field of the Invention

The present invention relates to a portable digital apparatus and a method of controlling the same, and more particularly, to a portable digital apparatus including a plurality of input buttons and a method of controlling the apparatus.

2. Description of the Related Art

In recent years, portable digital apparatuses such as mobile phones and digital cameras have become necessities. Such portable digital apparatuses are increasingly required to become smaller and lighter, and, at the same time, to allow the use of a larger number of characters. Therefore, methods of inputting a large number of characters using a limited number of input buttons are being studied.

A text input device is disclosed in U.S. Pat. No. 6,731,227 entitled “Qwerty Type Ten-key Board Based Character Input Device.” In this disclosure, since a plurality of alphabet letters are allocated to each input button of the device according to whether the device is inclined to the right or left, the device can perform a qwerty type input function. However, users of conventional text input devices cannot easily select characters of various language character sets (e.g., English capital letters, English lower case letters, non-English language characters, etc.) and characters of a non-language (e.g., numbers, symbols, emoticons, etc.) character set. To this end, a new text input device would be a significant improvement in the art.

### SUMMARY OF THE INVENTION

The present invention provides a portable digital apparatus for conveniently inputting characters of language (e.g., English alphabet characters, non-English characters, etc.) character sets and non-language (e.g., numbers, symbols, etc.) character sets, and a method of controlling the apparatus.

According to an aspect of the present invention, there is provided a portable digital apparatus including: a plurality of input buttons to each of which at least two characters of different language character sets are allocated; a sensor which senses an inclination, tilt or orientation of the apparatus; and a controller which selects one language character set according to the inclination of the apparatus detected by the inclination sensor.

According to another aspect of the present invention, there is provided a method of controlling a portable digital apparatus which includes a plurality of input buttons. The method includes: allocating at least two characters of different language character sets to at least one input button; and selecting a language character set according to inclination of the apparatus.

According to a portable digital apparatus and a method of controlling the same, language characters of a plurality of language character sets are allocated for each input button, and one of the plurality of language character sets is selected according to the inclination of the portable digital apparatus. Accordingly, a user can easily input various language and non-language characters by adjusting the inclination of the portable digital apparatus.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a mobile phone which can be inclined about an X axis according to a first embodiment of the present invention;

FIG. 2 is a block diagram illustrating an example internal configuration of the mobile phone of FIG. 1;

FIG. 3 illustrates a data input pad of the mobile phone of FIG. 1;

FIG. 4 illustrates a case where an example sentence is input using a data input pad of FIG. 3;

FIG. 5 illustrates a mobile phone which can be inclined about X and Y axes according to a second embodiment of the present invention;

FIG. 6 is a block diagram illustrating an example internal configuration of the mobile phone of FIG. 5;

FIG. 7 illustrates a data input pad of the mobile phone of FIG. 5 according to an embodiment of the present invention;

FIG. 8 illustrates a case where a first example sentence is input using the data input pad of FIG. 7;

FIG. 9 illustrates a case where a second example sentence is input using the data input pad of FIG. 7;

FIG. 10 illustrates a case where a third example sentence is input using the data input pad of FIG. 7;

FIG. 11 illustrates a method of dragging characters displayed on a display panel of the mobile phone of FIG. 5 according to an embodiment of the present invention.

FIG. 12 illustrates a data input pad of the mobile phone of FIG. 5 according to another embodiment of the present invention;

FIG. 13 illustrates English language characters which are displayed on the display panel of the mobile phone of FIG. 5 using the data input pad of FIG. 12 when the mobile phone of FIG. 5 is inclined such that the upper portion of the mobile phone is lower than the lower portion thereof according to an embodiment of the present invention;

FIG. 14 illustrates Korean language characters which are displayed on the display panel of the mobile phone of FIG. 5 using the data input pad of FIG. 12 when the mobile phone of FIG. 5 is not inclined such that the upper portion of the mobile phone is lower than the lower portion thereof and vice versa according to an embodiment of the present invention;

FIG. 15 illustrates numbers displayed on the display panel of the mobile phone of FIG. 5 using the data input pad of FIG. 12 when the mobile phone is inclined such that the lower portion of the mobile phone is lower than the upper portion thereof according to an embodiment of the present invention;

FIG. 16 illustrates a digital camera which can be inclined about X and Y axes according to a third embodiment of the present invention;

FIG. 17 illustrates English language capital letters displayed on a display panel of the digital camera of FIG. 16 when the digital camera is inclined such that an upper portion of the digital camera is lower than a lower portion thereof according to an embodiment of the present invention;

FIG. 18 illustrates English language lower case letters displayed on the display panel of the digital camera of FIG. 16 when the digital camera is not inclined such that the upper portion of the digital camera is lower than the lower portion thereof and vice versa according to an embodiment of the present invention;

FIG. 19 illustrates numbers displayed on the display panel of the digital camera of FIG. 16 when the digital camera is inclined such that the lower portion of the digital camera is lower than the upper portion thereof according to an embodiment of the present invention;

FIG. 20 illustrates a case where a first example sentence is input to the digital camera of FIG. 16 according to an embodiment of the present invention;

FIG. 21 illustrates a case where a second example sentence is input to the digital camera of FIG. 16 according to an embodiment of the present invention; and

FIG. 22 illustrates a qwerty-type digital apparatus which can be inclined about an X axis according to a fourth embodiment of the present invention.

### DETAILED DESCRIPTION OF THE EMBODIMENTS

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

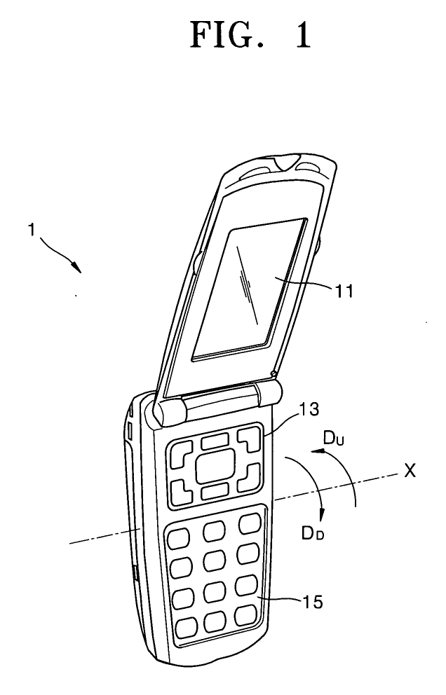

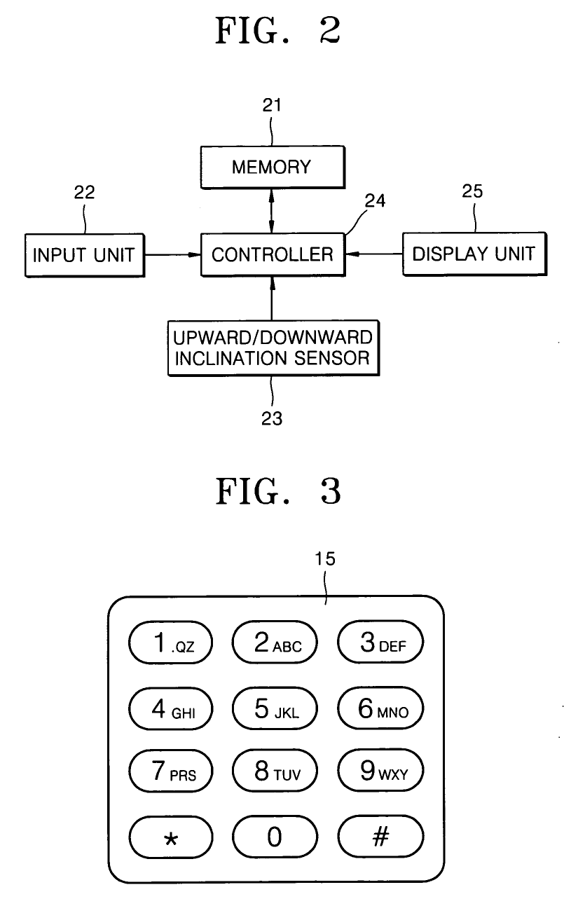

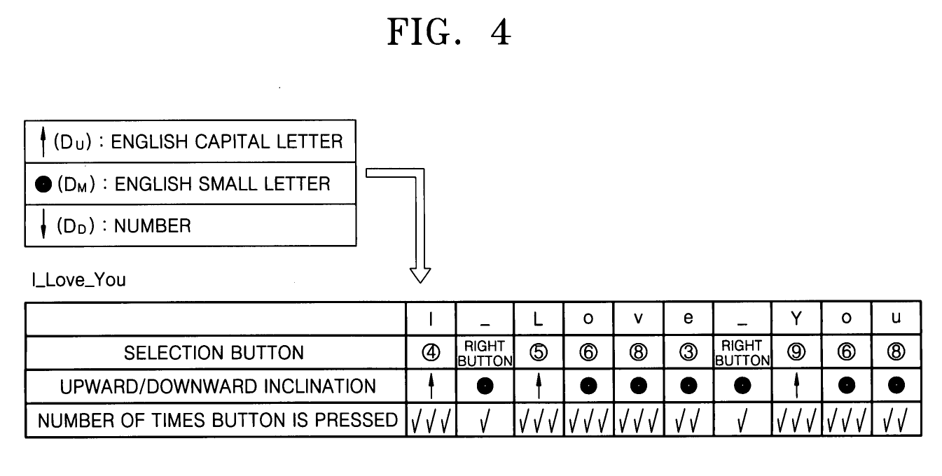

FIG. 1 illustrates a portable electronic device embodied as a mobile phone 1 which can be inclined about an X axis according to a first embodiment of the present invention. FIG. 2 is a block diagram illustrating an example internal configuration of the mobile phone 1 of FIG. 1. FIG. 3 illustrates a data input pad 15 of the mobile phone 1 of FIG. 1 according to an embodiment of the present invention. FIG. 4 illustrates a case where an example sentence is input using the data input pad 15 of FIG. 3.

In FIGS. 1 through 4, reference numeral D_{U} indicates a state where the mobile phone 1 is inclined or tilted about axis X such that an upper portion of the mobile phone 1 is oriented rearward with respect to a normal (untilted) orientation. Reference numeral D_{M} indicates a state where the mobile phone 1 is in its normal (untilted or not inclined) orientation, and reference numeral D_{D} indicates a state where the mobile phone 1 is inclined or tilted about axis X such that the lower portion of the mobile phone 1 is oriented rearward (and the upper portion of the mobile phone 1 is oriented forward) with respect to the normal orientation.

Referring to FIG. 1, the mobile phone 1 includes a display panel 11, a function input pad 13 and the data input pad 15. As shown in FIG. 2, the mobile phone 1 includes a memory 21, an input unit 22, an upward/downward inclination sensor 23, a controller 24, and a display unit 25. The upward/downward inclination sensor 23 may be various sensors or devices known in the art such as a gyroscope/gyrosensor, an inclinometer, an accelerometer or an angular speed sensor. The display unit 25 includes the display panel 11 and a driving unit of the display panel 11. The function input pad 13 includes various function buttons.

Two or more language character sets such as, for example, English language capital letters and English language lower case letters and, optionally, non-language character sets such as, for example, numbers and symbols are allocated to each of nine input buttons of the data input pad 15, and other characters are respectively allocated to the remaining three input buttons. Indeed, as will be explained hereafter, the character sets are not limited to the aforementioned numbers and English language characters, and may additionally or alternatively include non-English language characters.

The controller 24 performs the following input control function in response to a signal generated by the upward/downward inclination sensor 23. In the state D_{U} the controller 24 selects English language capital letters as the language character set for each of the nine input buttons. In the state D_{M} the controller 24 selects English language lower case letters as the language character set for each of the nine input buttons. In the state D_{D} the controller 24 selects numbers as the character set (i.e., a non-language character set).

A case where a user inputs the text “I Love You” using the data input pad 15 of FIG. 3 will now be described with reference to FIGS. 1, 3, and 4.

First, in the state D_{U}, if the user presses button “4” three times, English capital letter “I” is input. Then, when the user presses a right button on the function input pad 13, a blank space is input. In this embodiment, the right button can be used for entering a blank space regardless of whether the mobile phone 1 is inclined. In the state D_{U}, if the user presses button “5” three times, capital letter “L” is input.

In the state D_{M} where the mobile phone 1 is in its normal (untilted, not inclined) orientation, if the user presses button “6” three times, small letter “o” is input. Then, in the state D_{M}, if the user presses button “8” three times, small letter “v” is input. In the state D_{M}, if the user presses button “3” twice, small letter “e” is input. Next, if the user presses the right button on the function input pad 13, a blank is input. As mentioned above, the right button can be used for entering a blank space regardless of whether the mobile phone 1 is inclined.

In the state D_{U}, if the user presses button “9” three times, English capital letter “Y” is input. Next, in the state D_{M}, if the user presses the button “6” three times, small letter “o” is input. In the state D_{M}, if the user presses the button “8” twice, small letter “u” is input.

Indeed, a user may customize or otherwise set the language and non-language character sets differently from the first embodiment. For example, in the state D_{U}, small letters may be selected as a first language character set for each of the nine buttons, and, in the state D_{M}, numbers may be selected as a non-language character set. In addition, in the state D_{D}, small letters may be selected as a second language character set for each of the nine buttons.

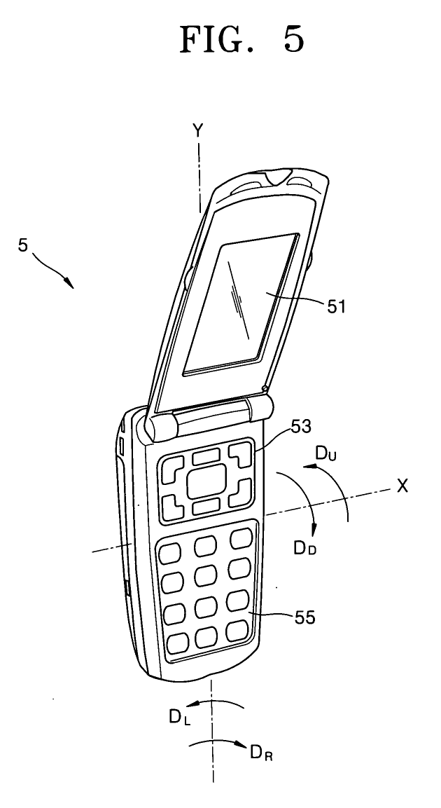

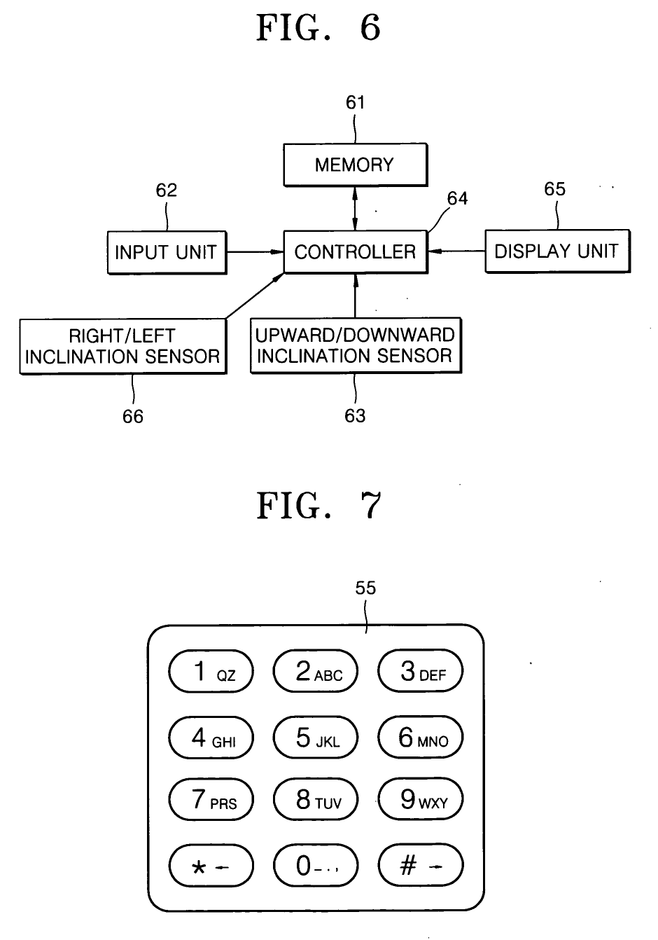

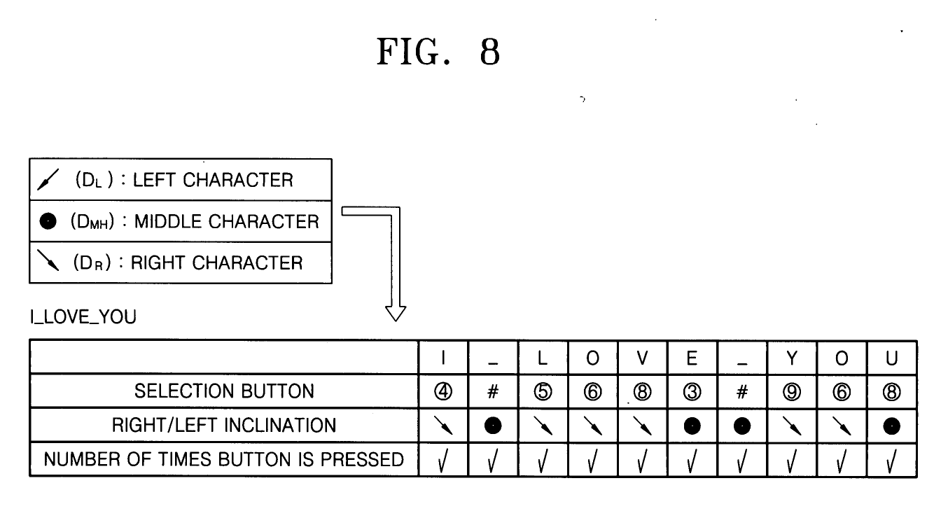

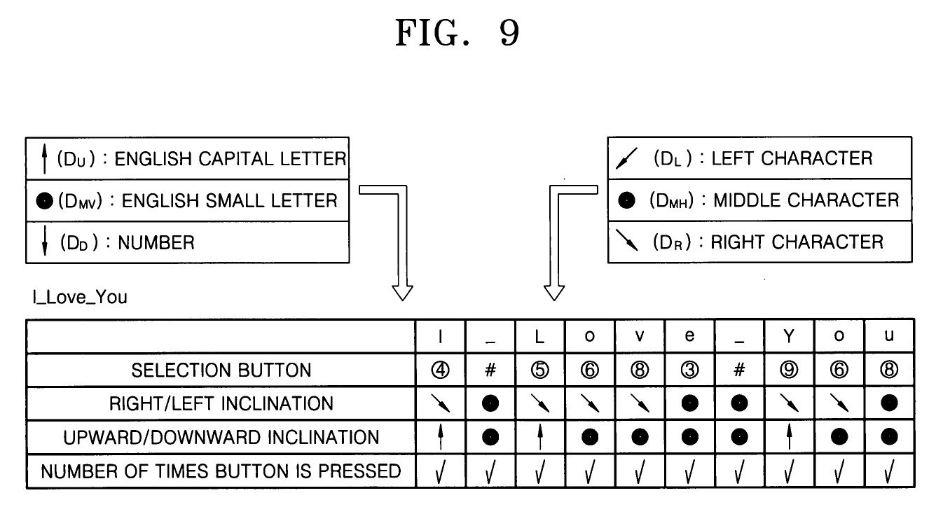

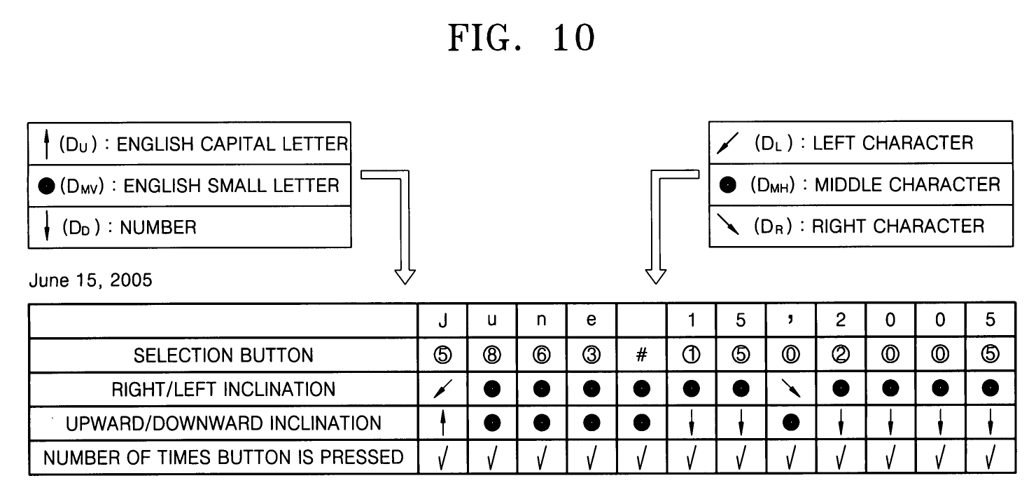

FIG. 5 illustrates a portable electronic device embodied as a mobile phone 5 which can be inclined about X and Y axes through the phone according to a second embodiment of the present invention. FIG. 6 is a block diagram illustrating an example internal configuration of the mobile phone 5 of FIG. 5. FIG. 7 illustrates a data input pad 55 of the mobile phone 5 of FIG. 5 according to an embodiment of the present invention. FIG. 8 illustrates a case where a first example sentence is input using the data input pad 55 of FIG. 7. FIG. 9 illustrates a case where a second example sentence is input using the data input pad 55 of FIG. 7. FIG. 10 illustrates a case where a third example sentence is input using the data input pad 55 of FIG. 7.

In FIGS. 5 through 10, reference numeral D_{U} again indicates a state where the mobile phone 5 is inclined or tilted about axis X such that an upper portion of the mobile phone 5 is oriented rearward with respect to a normal (untilted) orientation. Reference numeral D_{MV} indicates a state where the mobile phone 5 is not inclined or tilted about axis X (i.e., the normal X orientation), and reference numeral D_{D} again indicates a state where the mobile phone 5 is inclined or tilted about axis X such that the lower portion of the mobile phone 1 is oriented rearward (and the upper portion of the mobile phone 5 is oriented forward) with respect to the normal orientation. Reference numeral D_{L} indicates a state where the mobile phone 5 is inclined or tilted about axis Y such that a left portion of the mobile phone 5 is oriented rearward, reference numeral D_{MH} indicates a state where the mobile phone 5 is not inclined or tilted to the right or left about axis Y (i.e., the normal Y orientation), and reference numeral D_{R} indicates a state where the right portion of the mobile phone 5 is inclined or tilted rearward about axis Y.

Referring to FIG., the mobile phone 5 includes a display panel 51, a function input pad 53 and the data input pad 55. As shown in FIG. 6, the mobile phone 5 includes a memory 61, an input unit 62, an upward/downward inclination sensor 63, a controller 64, a display unit 65, and a right/left inclination sensor 66. The input unit 62 includes the function input pad 53 and the data input pad 55. The upward/downward inclination sensor 63 and the right/left inclination sensor 66 are formed according to a direction in which a gyroscope/gyrosensor, inclinometer(s), accelerometer(s) or angular speed sensor(s) are disposed. Although two sensors 63, 66 are shown, the sensors may be alternatively embodied by a single sensor that is operative to detect inclination about two or more axes. The display unit 65 includes the display panel 51 and a driving unit of the display panel 51. The function input pad 53 includes various function buttons.

At least two language character sets (e.g., English language capital letters, English language lower case letters, etc.) and a non-language character set (e.g., numbers, symbols, etc.) are allocated to each of nine input buttons of the data input pad 55, and other characters (e.g., blank space) are respectively allocated to the remaining three input buttons.

The controller 64 performs the following input control function in response to a signal generated by the upward/downward inclination sensor 63. In the state D_{U}, the controller 64 selects English language capital letters as a language character set for each of the nine input buttons. In the state D_{MV}, the controller 64 selects English language small (i.e., lower case) letters as a language character set. In the state D_{D}, the controller 24 selects numbers as a (non-language) character set.

In response to a signal generated by the right/left inclination sensor 66, the controller 64 selects one of a plurality of characters (e.g., two or three characters) assigned to the button being actuated. In other words, to obviate the need to press a single button multiple times, the controller 64 performs the following input control function:

In the state D_{L}, the controller 64 selects a character on the left from the two or three characters of a selected character set that are assigned to a button. In the state D_{MH}, the controller 64 selects a character in the middle of three assigned characters. In the state D_{R}, the controller 64 selects a character on the right from the two or three characters.

A case where a user inputs “I LOVE YOU” using the data input pad 55 of FIG. 7 will now be described with reference to FIGS. 5, 7, and 8. In this case, since only English language capital letters are input, the mobile phone 5 remains in the X-axis orientation state D_{U}.

In the state D_{R}, if a user presses button “4,” capital letter “I” on the right of capital letters “G,” “H,” and “I” allocated to the button “4” is input.

Then, in the state D_{MH}, if the user presses a “#” button, right arrow symbol “→” in the middle of the “#” button is selected to input a blank space accordingly. The pound sign symbol “#” of the “#” button is selected in the state D_{D} where the mobile phone 5 is inclined with respect to the X-axis such that the lower portion of the mobile phone 5 is tilted rearward.

In the state D_{R}, if the user presses button “5,” capital letter “L” on the right is input. Next, in the state D_{R}, if the user presses button “6,” capital letter “O” on the right is input. If the user presses button “8,” capital letter “V” is input. Then, in the state D_{MH}, if the user presses button “3,” capital letter “E” in the middle is input. In the state D_{MH}, if the user presses the “#” button, the right arrow symbol “→” is selected and a blank space is input accordingly.

In the state D_{R}, if the user presses button “9,” capital letter “Y” on the right is input. In the state D_{R}, if the user presses button “6,” capital letter “O” is input. In the state D_{MH}, if the user presses button “8,” capital letter “U” in the middle is input.

A case where a user inputs “I Love You” using English language capital and lower case letters, the data input pad 55 of FIG. 7 will now be described with reference to FIGS. 5, 7, and 9.

In the states D_{U} and D_{R}, if the user presses the button “4,” the capital letter “I” on the right is input. In the states D_{MV} and D_{MH}, if the user presses the “#” button, the right arrow symbol “→” in the middle is selected and a blank space is input accordingly.

In the states D_{U} and D_{R}, if the user presses the button “5,” the capital letter “L” on the right is input. In the states D_{MV} ad D_{R}, if the user presses the button “6,” small letter “o” on the right is input. Next, in the states D_{MV} and D_{R}, if the user presses the button “8,” small letter “v” on the right is input. In the states D_{MV} and D_{MH}, if the user presses the button “3,” small letter “e” in the middle is input.

In the states D_{MV} and D_{MH}, if the user presses the “#” button, the right arrow symbol “→” is selected and a blank space is input accordingly. In the states D_{U} and D_{R}, if the user presses the button “9,” capital letter “Y” on the right is input. In the states D_{MV} and D_{R}, if the user presses the button “6,” small letter “o” on the right is input. In the states D_{MV} and D_{MH}, if the user presses the button “8,” small letter “u” in the middle is input.

A case where a user inputs the text “June 15, 2005” using the data input pad 55 of FIG. 7 will now be described with reference to FIGS. 5, 7, and 10.

In the states D_{U} and D_{L}, if the user presses the button “5,” capital letter “J” on the left is input. In the states D_{MV} and D_{MH}, if the user presses the button “8,” small letter “u” in the middle is input. In the states D_{MV} and D_{MH}, if the user presses the button “6,” small letter “n” in the middle is input. In the states D_{MV} and D_{MH}, if the user presses the button “3,” small letter “e” in the middle is input.

In the states D_{MV} and D_{MH}, if the user presses the “#” button, the right arrow symbol “→” is selected and a blank space is input accordingly. In the state D_{D}, if the user presses button “1,” number “1” is input. Since each input button includes only one number, whether the mobile phone 5 is inclined to the right or left may not be considered in the state D_{D}. Next, in the state D_{D}, if the user presses the button “5,” number “5” is input. In the states D_{MV} and D_{R}, if the user presses button “0,” symbol “,” on the right of symbols allocated to the button “0” is input.

In the state D_{D}, if the user presses button “2,” number “2” is input. As described above, since each input button includes only one number, whether the mobile phone 5 is inclined to the right or left may not be considered in the state D_{D}. Next, in the state D_{D}, if the user presses the button “0” twice, the number “0” is input twice. In the states D_{D}, if the user presses the button “5,” number “5” is input.

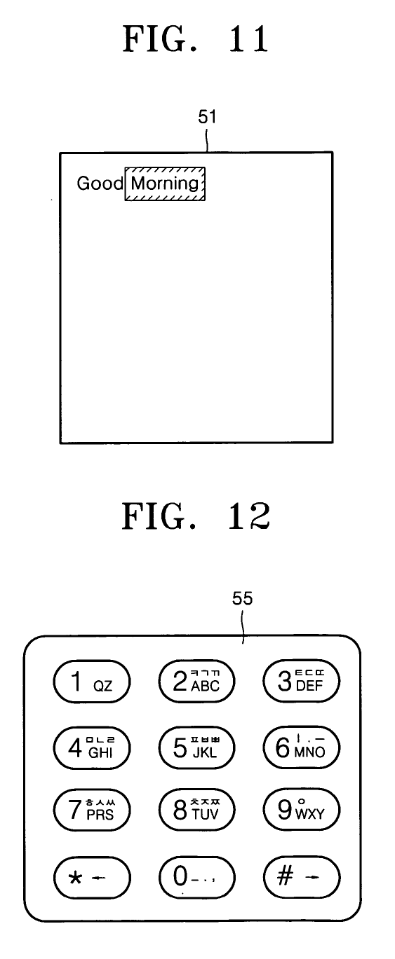

A method of dragging characters displayed on the display panel 51 of the mobile phone 5 will now be described with reference to FIGS. 7 and 11. To input a last letter “g” in a word “Morning,” if a user presses the button “4” in the states D_{MV} and D_{L}, small letter “g” on the left is input. If the user maintains the mobile phone 5 not inclined to the right or left and then presses a “*” button, the letter “g” and letters input before “g” are selected while the “*” button is pressed.

Indeed, as with the first embodiment, a user may customize or otherwise set the character sets differently from the above example. For example, in the state D_{U}, numbers may be selected as a (non-language) character set for each of the nine input buttons. Also, in the state D_{MV}, English language capital letters may be selected as a (first language) character set. In the state D_{D}, English language lower case letters may be selected as a (second language) character set. As should be appreciated, the foregoing embodiments are not intended to be limiting on the invention as other embodiments may employ fewer or additional character sets, which may be assigned to the buttons as desired.

A user may set one language character set to be a different language from that of another character set. For example, the manufacturer or user may set or select, respectively, one language character set to be Korean and another language character set to be English. Also, the user need not assign a language to one or more of the character sets. For example, one character set may be numbers and another character set may be, for example, emoticons, symbols or punctuation marks.

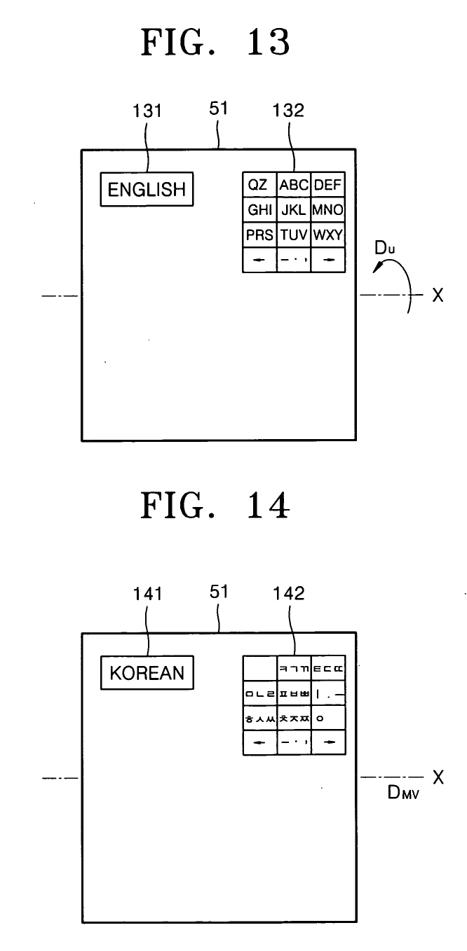

FIG. 12 illustrates a data input pad 55 of the mobile phone 5 of FIG. 5 according to another embodiment of the present invention. FIG. 13 illustrates characters in English as a first language character set which are displayed on the display panel 51 of the mobile phone 5 of FIG. 5 using the data input pad 55 of FIG. 12 when the mobile phone 5 is inclined such that the upper portion of the mobile phone 5 is oriented rearward with respect to a normal (untilted) orientation, according to an embodiment of the present invention.

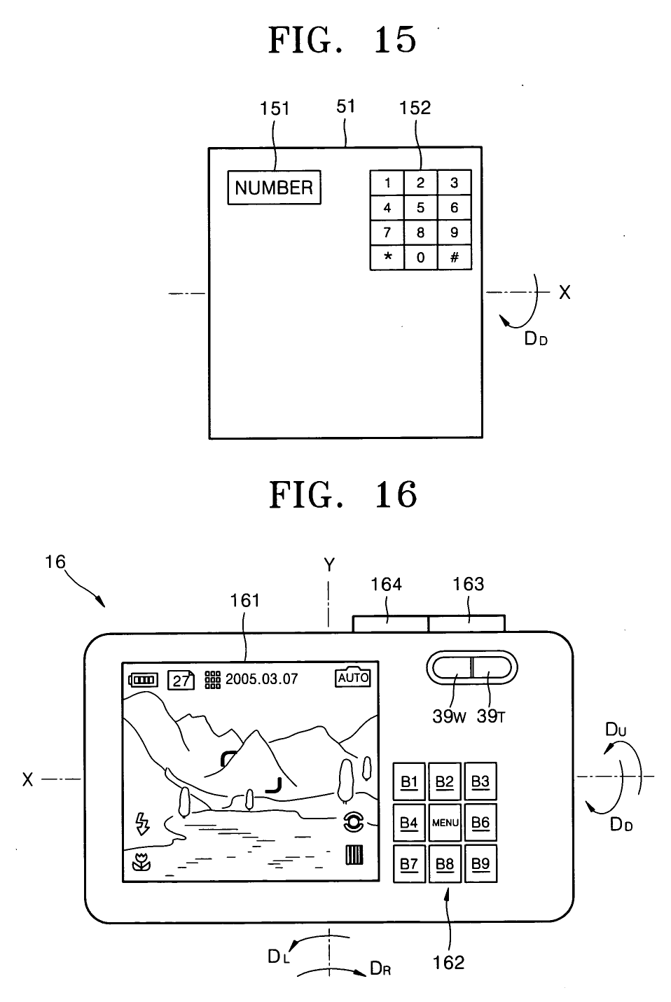

FIG. 14 illustrates characters in Korean as a second language character set which are displayed on the display panel 51 of the mobile phone 5 using the data input pad 55 of FIG. 12 when the mobile phone 5 of FIG. 5 is not inclined (i.e., the normal orientation), according to an embodiment of the present invention. FIG. 15 illustrates numbers as a non-language character set which are displayed on the display panel 51 of the mobile phone 5 of FIG. 5 using the data input pad 55 of FIG. 12 when the bottom portion of mobile phone 5 is oriented rearward (and the upper portion of the mobile phone 5 is oriented forward) with respect to the normal orientation, according to an embodiment of the present invention.

Referring to FIGS. 12 through 15, English language characters, Korean language characters, and numbers are allocated to each of nine input buttons of the data input pad 55, and other characters (e.g., a blank space) are respectively allocated to the remaining three input buttons. Accordingly, the following input control is performed.

First, in the state D_{U} where the mobile phone 5 is inclined such that the upper portion of the mobile phone 5 is oriented rearward relative to the normal orientation, English is selected as a language character set for each of the nine input buttons. In this case, “English” 131, which is the selected character set, and English language characters 132 are displayed on the display panel 51 of the mobile phone 5 of FIG. 5 for user convenience. Here, the English language characters 132 are arranged as those in the data input pad 55 of the mobile phone 5 of FIG. 5.

Second, in the state D_{MV} where the mobile phone 5 is not inclined (i.e., the normal orientation), Korean is selected as a language character set for each of the nine input buttons. In this case, “Korean” 141, which is the selected character set, and Korean language characters 142 are displayed on the display panel 51 of the mobile phone 5 of FIG. 5 for user convenience. Here, the Korean language characters 142 are arranged as those in the data input pad 55 of the mobile phone 5.

Third, in the state D_{D} where the mobile phone 5 is inclined such that the lower portion of the mobile phone 5 is oriented rearward relative to the normal orientation, number is selected as a (non-language) character set for each of the nine input buttons. In this case, “Number” 151, which is the selected character set, and numbers 152 are displayed on the display panel 51 of the mobile phone 5 of FIG. 5 for user convenience. Here, the numbers 152 are arranged as those in the data input pad 55 of the mobile phone 5.

As described above, one of a plurality of characters of a selected character set, e.g., English or Korean, for an input button is selected according to whether the mobile phone 5 is inclined.

Korean language characters are classified into characters to be placed on the left of a button, in the middle of a button and on the right of a button, and are allocated to each of some of the input buttons accordingly. In this case, aspirated consonants are placed on the left, lenis consonants are placed in the middle, and fortis consonants are placed on the right such that the Korean language characters can be easily recognized.

Specifically, the aspirated consonants [symbol] and [symbol] are respectively allocated to the left of the buttons “2,” “3,” “5,” and “8.” The lenis consonants [symbol] and [symbol] are respectively allocated to the middle of the buttons “2,” “3,” “5,” and “8.” The fortis consonants [symbol] and [symbol] are respectively allocated to the right of the buttons “2,” “3,” “5,” and “8.”

Hence, when the mobile phone 5 is inclined such that the left portion of the mobile phone 5 is lower than the right portion thereof, the aspirated consonants [symbol] and [symbol] are selected. When the mobile phone 5 is not inclined either to the right or left, the lenis consonants [symbol] and [symbol] are selected. When the mobile phone 5 is inclined such that the right portion of the mobile phone 5 is lower than the left portion thereof, the fortis consonants [symbol] and [symbol] are selected.

First through third basic vowels [symbol] “.,” and “—,” which combine to form vowels, are allocated to the button “6.” When the mobile phone 5 is inclined such that the left portion of the mobile phone 5 is oriented rearward relative to a normal (untilted) orientation, the first basic vowel [symbol] is selected. When the mobile phone 5 is not inclined to the right or left (i.e., the normal orientation), the second basic vowel “.” is selected. When the mobile phone 5 is inclined such that the right portion of the mobile phone 5 is oriented rearward relative to a normal (untilted) orientation, the third basic vowel “—” is selected. Hence, the Korean language characters can be easily recognized.

The present embodiment may be applied to multi-lingual portable electronic devices such as mobile phones, digital cameras or the like that are sold in both English-speaking and Korean-speaking countries, for example, devices manufactured by Samsung Electronics Co., Ltd. In mobile phones manufactured by Samsung Electronics, the first basic vowel [symbol] is allocated to the button “1,” the second basic vowel “.” is allocated to the button “2,” and the third basic vowel “—” is allocated to the button “3.” Although English and Korean language characters are used herein for purposes of example, other language characters such as Japanese, Chinese, etc. may be used.

The lenis consonants [symbol] and [symbol] are respectively allocated to the left of the buttons “4,” “6,” “7,” and “9.” The aspirated consonants [symbol] and [symbol] are respectively allocated to the middle of the buttons “4,” “6,” “7,” and “9.” The fortis consonants [symbol] and [symbol] are respectively allocated to the right of the buttons “4,” “6,” “7,” and “9.”

In this case, when the mobile phone 5 is inclined such that the left portion of the mobile phone 5 is oriented rearward relative to a normal (untilted) orientation, the lenis consonants [symbol] and [symbol] are selected. When the mobile phone 5 is not inclined to the right or left (i.e., the normal orientation), the aspirated consonants [symbol] and [symbol] are selected. When the mobile phone 5 is inclined such that the right portion of the mobile phone 5 oriented rearward relative to a normal (untilted) orientation, the fortis consonants [symbol] and [symbol] are selected.

FIG. 16 illustrates a digital camera 16 which can be inclined about X and Y axes according to a third embodiment of the present invention. Referring to FIG. 16, reference numeral 161 indicates a display panel, reference numeral 162 indicates nine input buttons, reference numeral 163 indicates a shutter release button, reference numeral 164 indicates mode buttons for setting an operating mode, reference numeral 39_{W} indicates a wide-angle zoom button, and reference numeral 369_{T} indicates a telephoto zoom button.

The wide-angle zoom button 39_{W} is used as a left button in a user input mode of the digital camera 16, and the telephoto zoom button 39_{T} is used as a right button in the user input mode.

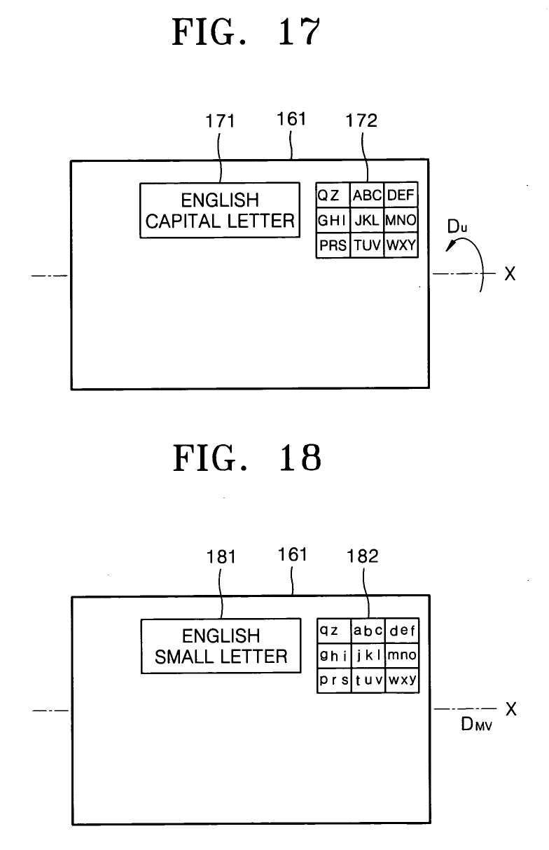

FIG. 17 illustrates English language capital letters displayed on the display panel 161 of the digital camera 16 of FIG. 16 when the digital camera 16 is inclined such that an upper portion of the digital camera 16 is oriented rearward relative to a normal (untilted) orientation, according to an embodiment of the present invention. FIG. 18 illustrates English small (i.e., lower case) letters displayed on the display panel 161 of the digital camera 16 of FIG. 16 when the digital camera 16 is not inclined (i.e., the normal orientation), according to an embodiment of the present invention.

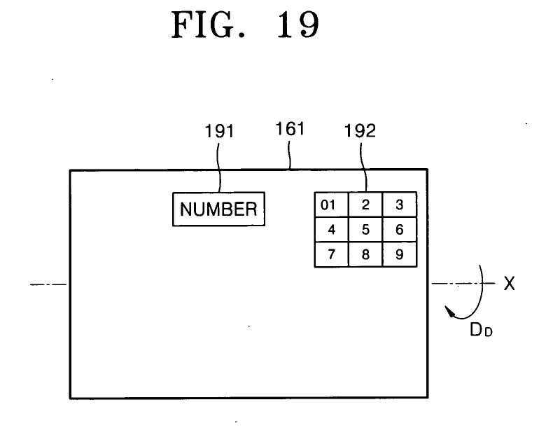

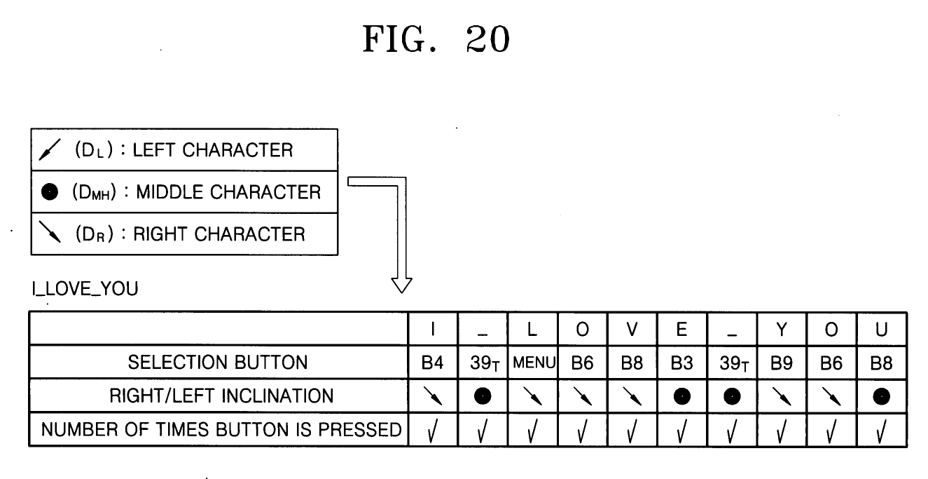

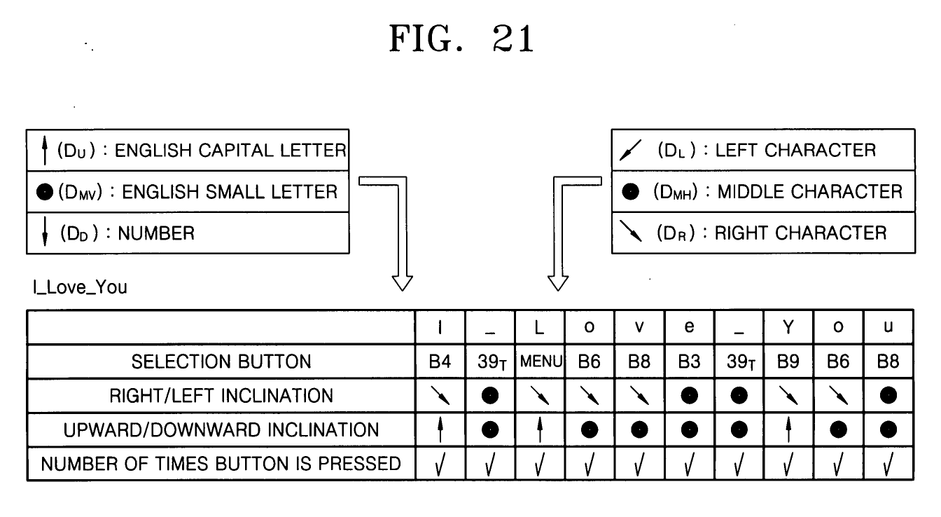

FIG. 19 illustrates numbers displayed on the display panel 161 of the digital camera 16 of FIG. 16 when the digital camera 16 is inclined such that the lower portion of the digital camera 16 is oriented rearward relative to a normal (untilted) orientation, according to an embodiment of the present invention. FIG. 20 illustrates a case where a first example sentence is input to the digital camera 16 of FIG. 16 according to an embodiment of the present invention. FIG. 21 illustrates a case where a second example sentence is input to the digital camera 16 of FIG. 16 according to an embodiment of the present invention.

Referring to FIGS. 16 through 21, English language capital letters, English language small letters, and numbers are allocated to each of the illustrated nine input buttons 162. Accordingly, the following input control is performed.

First, in the state D_{U} where the digital camera 16 is inclined such that the upper portion of the digital camera 16 is oriented rearward relative to a normal (untilted) orientation, English language capital letter is selected as a language character set for each of the nine input buttons 162. In this case, “English capital letter” 171, which is the selected character set, and English capital letters 172 are displayed on the display panel 161 of the digital camera 16 for user convenience. Here, the English language capital letters 172 (FIG. 17) are arranged to correspond with the nine input buttons 162 of the digital camera 16.

Second, in the state D_{MV} where the digital camera 16 is not inclined (i.e., the normal orientation), English small letter is selected as a language character set for each of the nine input buttons 162. In this case, “English small letter” 181, which is the selected character set, and English small letters 182 (FIG. 18) are displayed on the display panel 161 of the digital camera 16 for user convenience. Here, the English small letters 182 are arranged to correspond with the nine input buttons 162 of the digital camera 16.

Third, in the state D_{D} where the digital camera 16 is inclined such that the lower portion of the digital camera 16 is oriented rearward relative to a normal (untilted) orientation, number is selected as a (non-language) character set for each of the nine input buttons 162. In this case, “Number” 191, which is the selected character set, and numbers 192 (FIG. 19) are displayed on the display panel 161 of the digital camera 16 for user convenience. Here, the numbers 192 are arranged to correspond with the nine input buttons 162 of the digital camera 16.

As described above, one of a plurality of characters of a selected character set, e.g., English language capital letters or English language small letters, for an input button is selected according to whether the digital camera 16 is inclined. Accordingly, the following input control is performed.

In the state D_{L} where the digital camera 16 is inclined such that the left portion of the digital camera 16 is oriented rearward relative to a normal (untilted) orientation, a controller selects a character on the left (of two or three characters assigned to a button) from characters of a selected character set. In the state D_{MH} where the digital camera 16 is not inclined to the right or left, the controller selects a character in the middle (of three characters). In the state D_{R} where the right portion of the digital camera 16 is oriented rearward relative to a normal (untilted) orientation, the controller selects a character on the right (of two or three characters assigned to a button).

A case where a user inputs “I LOVE YOU” to the digital camera 16 will now be described with reference to FIGS. 16, 17, and 20. In this case, since only English language capital letters are input to the digital camera 16, the digital camera 16 remains in the state D_{U} where the digital camera 16 is inclined such that the upper portion of the digital camera 16 is oriented rearward relative to a normal (untilted) orientation.

In the state D_{R} where the right portion of the digital camera 16 is oriented rearward relative to a normal (untilted) orientation, if a user presses button “B4,” capital letter “I” on the right of capital letters “G,” “H,” and “I” allocated to the button “B4” is input.

Then, in the user input mode, if the user presses the telephoto zoom button 39_{T} used as the right button, a blank space is input. In this embodiment, the telephoto zoom button 39_{T} can be used as the right button for inputting a blank space regardless of the inclination of the digital camera 16.

In the state D_{R}, if the user presses a “MENU” button (FIG. 16), capital letter “L” on the right is input. Next, in the state D_{R}, if the user presses button “B6,” capital letter “O” on the right is input. If the user presses button “B8,” capital letter “V” is input. Then, in the state D_{MH}, if the user presses button “B3,” capital letter “E” in the middle is input. In the user input mode, if the user presses the telephoto zoom button 39_{T} used as the right button, a blank space is input.

In the state D_{R}, if the user presses button “B9” capital letter “Y” on the right is input. Next, in the state D_{R}, if the user presses button “B6,” capital letter “O” on the right is input. Then, in the state D_{MH}, if the user presses button “B8,” capital letter “U” in the middle is input.

A case where a user inputs “I Love You” to the digital camera 16 will now be described with reference to FIGS. 16, 17, 18, and 21.

In the states D_{U} and D_{R}, if the user presses the button “B4,” the capital letter “I” on the right is input. Then, in the user input mode, if the user presses the telephoto zoom button 39_{T} used as the right button, a blank space is input. As mentioned above, the telephoto zoom button 39_{T} can be used as the right button for inputting a blank space regardless of the inclination of the digital camera 16.

In the states D_{U} and D_{R}, if the user presses the “MENU” button, the capital letter “L” on the right is input. In the states D_{MV} ad D_{R}, if the user presses the button “B6,” small letter “o” on the right is input. Next, in the states D_{MV} and D_{R}, if the user presses the button “B8,” small letter “v” on the right is input. In the states D_{MV} and D_{MH}, if the user presses the button “B3,” small letter “e” in the middle is input.

Then, in the user input mode, if the user presses the telephoto zoom button 39_{T} used as the right button, a blank space is input. In the states D_{U} and D_{R}, if the user presses the button “B9,” capital letter “Y” on the right is input. In the states D_{MV} and D_{R}, if the user presses the button “B6,” small letter “o” on the right is input. In the states D_{MV} and D_{MH}, if the user presses the button “B8,” small letter “u” in the middle is input.

A user may set the language and non-language character sets differently from the third embodiment. For example, in the state D_{U}, small letters may be selected as a language character set for each of the nine buttons 162, and in the state D_{M}, numbers may be selected as a non-language character set. In addition, in the state D_{D}, capital letters may be selected as a language character set.

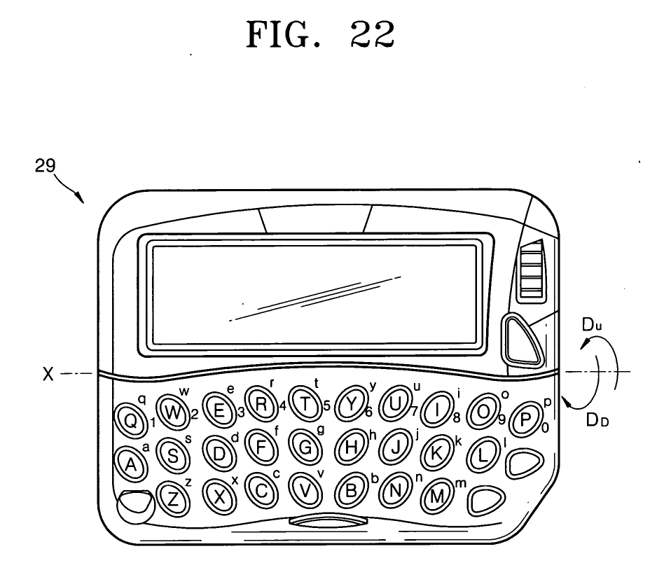

FIG. 22 illustrates a qwerty-type digital apparatus 29 which can be inclined about an X axis according to a fourth embodiment of the present invention. Referring to FIG. 22, the qwerty-type digital apparatus 29 performs the following input functions.

First, in a state D_{U} where the qwerty-type digital apparatus 29 is inclined such that an upper portion of the qwerty-type digital apparatus 29 is oriented rearward relative to a normal (untilted) orientation, English small letter is selected as a language character set for each input button. Second, in a state where the qwerty-type digital apparatus 29 is not inclined (i.e., the normal orientation), English language capital letter is selected as a character set for each input button. Third, in a state D_{D} wherein the qwerty-type digital apparatus 29 is inclined such that the lower portion of the qwerty-type digital apparatus 29 is oriented rearward relative to a normal (untilted) orientation, number is selected as a non-language character set.

As described above, according to a portable digital apparatus and a method of controlling the same, characters of a plurality of language character sets are allocated for each input button, and one of the language character sets is selected according to the inclination of the portable digital apparatus. Accordingly, a user can easily input characters of various language sets by adjusting the inclination of the portable digital apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A portable digital apparatus comprising:
a display;
a plurality of input buttons;
a sensor detecting an orientation of the apparatus; and
a controller in communication with the display, the plurality of input buttons and the sensor,
wherein, upon actuation of an input button of the plurality, the controller displays a character of first and second language character sets on the display according to the orientation detected by the sensor.

2. The portable digital apparatus of claim 1 wherein the sensor is selected from the group consisting of inclinometers, gyroscopes and accelerometers.

3. The portable digital apparatus of claim 1 wherein the plurality of input buttons comprises a data input pad including at least ten buttons.

4. The portable digital apparatus of claim 1 wherein English language lower case letters comprise one of the first and second language character sets.

5. The portable digital apparatus of claim 1 wherein English language capital letters comprise one of the first and second language character sets.

6. The portable digital apparatus of claim 1 wherein the controller further displays a character of a non-language character set on the display relative to an orientation that is different from the orientation for displaying the character of the first and second language character sets.

7. The portable digital apparatus of claim 1 wherein one of the first and second language character sets comprises non-English language characters.

8. The portable digital apparatus of claim 7 wherein the non-English language characters comprise Korean characters.

9. The portable digital apparatus of claim 1 wherein the sensor detects the orientation with respect to inclination about a first axis through the apparatus.

10. The portable digital apparatus of claim 9 further comprising a second sensor for detecting a second orientation of the apparatus with respect to inclination about a second axis through the apparatus and being generally perpendicular to the first axis.

11. A method of inputting text to a portable digital apparatus including a display, an orientation sensor and a plurality of input buttons, the method comprising:
assigning language characters of first and second language character sets to the plurality of input buttons;
selecting one of the first and second language character sets;
detecting actuation of an input button of the plurality; and
according to the selecting step, displaying on the display a language character from the selected one of the first and second language character sets.

12. The method of claim 11 wherein the selecting step comprises the orientation sensor determining a first inclination of the apparatus with respect to a first axis through the apparatus.

13. The method of claim 12 wherein the detecting step further comprises a second orientation sensor detecting a second inclination of the apparatus with respect to a second axis through the apparatus being generally perpendicular to the first axis.

14. The method of claim 11 wherein the assigning step comprises:
allocating English language capital letters to the plurality of input buttons; and
allocating English language lower case letters to the plurality of input buttons.

15. The method of claim 11 wherein the assigning step comprises:
allocating characters of a first language to the plurality of input buttons; and
allocating characters of a second language to the plurality of input buttons.

16. The method of claim 15 wherein at least one of the first and second languages comprise English.

17. The method of claim 15 wherein at least one of the first and second languages comprise Korean.

18. A method for entering text into a portable electronic device including an inclination sensor, a display and a keypad having at least ten buttons, the method comprising:
allocating at least two language character sets selected from the group consisting of lower case English language characters, capital English language characters, non-English language characters to said at least ten buttons;
selecting one of said at least two language character sets according to the inclination sensor;
displaying on the display an indication of the one selected language character set;
detecting actuation of a button of said at least ten buttons; and
according to the detecting step, displaying on the display a character of the one selected language character set.

19. The method of claim 18 wherein the selecting step comprises determining a backward or forward tilting of the portable electronic device with respect to a normal, untilted orientation.

20. The method of claim 18 wherein the allocating step further comprises assigning a left character, a middle character and a right character to each of said at least ten buttons, and wherein the detecting step further comprises determining a rightward or leftward tilting of the portable electronic device with respect to a normal untilted orientation.
